(19) United States
(12) Patent Application Publication
(10) Pub. No.: US 2016/0048911 A1
(43) Pub. Date: Feb. 18, 2016

(54) BID OVERSIGHT SYSTEM AND METHOD

(71) Applicant: Staecy Carpenter, San Jose, CA (US)

(72) Inventor: Staecy Carpenter, San Jose, CA (US)

(21) Appl. No.: 14/928,453

(22) Filed: Oct. 30, 2015

Related U.S. Application Data
(63) Continuation-in-part of application No. 13/854,097, filed on Mar. 31, 2013.
(60) Provisional application No. 61/619,829, filed on Apr. 3, 2012.

(51) Int. Cl. G06Q 30/08; G06Q 10/10

(52) U.S. Cl. CPC G06Q 30/08; G06Q 10/1095

(57) ABSTRACT

Oversight system includes receiving, by a meeting auction entity within a bid oversight system from a meeting host on a host system, meeting information about a meeting. The meeting information includes availability dates, type of meeting, and a minimum bid amount. A bidder using a bidder system initiates a bid. The bidder provides information about the bid from the bidder system to the bid oversight system. The information includes bidder contact information, bid price, and a proposed parameter document or video for a meeting.

### BACKGROUND

Meaningful business relationships often begin after a first meeting, which may occur by videoconference, an on-line meeting or, in the best case scenario, meeting in person. Meaningful meetings can be defined as time well spent; a person's time is very valuable and can be easily wasted if the parties involved in the meeting have not properly communicated the goals and purpose of the meeting beforehand. To help ensure meetings are productive and effective, an agenda can provide a clear understanding of expectations for all parties involved prior to the meeting. Traditionally, when a business introduction is facilitated between two parties (i.e. buyers and sellers), an agenda is prepared, presented and reviewed to confirm expectations before the meeting begins. An agenda generally states what is to be accomplished in the meeting with names and titles of those attending. Depending on the reason for the meeting, a proposal may be presented.

### BRIEF DESCRIPTION OF THE DRAWINGS

FIG. 1 shows a block diagram of a bid system used to allow bidding for meeting, in accordance with an embodiment.

FIG. 1A is a screenshot of information on-line about a meeting auction process, in accordance with an embodiment.

FIG. 1B is a screenshot of an on-line meeting auction, in accordance with an embodiment.

FIG. 2A is a screenshot of a place bid form with meeting agenda or proposal document upload requirement and meeting criteria.

FIG. 2B summarizes flow of a bidding process.

FIG. 2C is a screenshot of a message for requirement to upload a document before proceeding with placing a bid, in accordance with an embodiment.

FIG. 3A shows an example of an agenda in accordance with an embodiment.

FIG. 3B shows an example of a response to request for proposal in accordance with an embodiment.

FIG. 4 is a screenshot of email communication informing meeting host of a new bid with link to view agenda document, in accordance with an embodiment.

FIG. 5A is a screenshot of an on-line form for registering as a meeting host, in accordance with an embodiment.

FIG. 5B is a screenshot of the meeting host control panel and account dashboard where meetings are added, edited, deleted and viewed, in accordance with an embodiment.

FIG. 5C is a screenshot of the meeting host account dashboard where meetings are accepted, denied, scheduled and where information submitted is viewed, in accordance with an embodiment.

FIG. 5D is a screenshot of an on-line form for adding a meeting auction with requirements, in accordance with an embodiment.

FIG. 6 is a meeting disclaimer, in accordance with an embodiment.

FIG. 7A is an illustration of Frequently Asked Questions, page 1 of 3, in accordance with an embodiment.

FIG. 7B is an illustration of Frequently Asked Questions, page 2 of 3, in accordance with an embodiment.

FIG. 7C is an illustration of Frequently Asked Questions, page 2 of 3, in accordance with an embodiment.

FIG. 8 is an illustration of a meeting auction flow chart, in accordance with an embodiment.

### DESCRIPTION OF THE EMBODIMENT

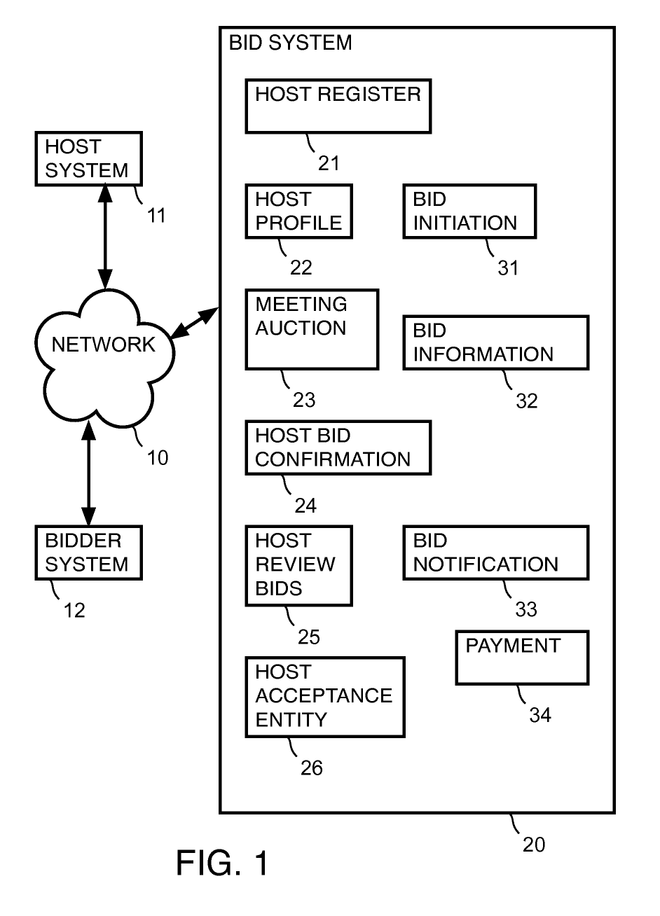

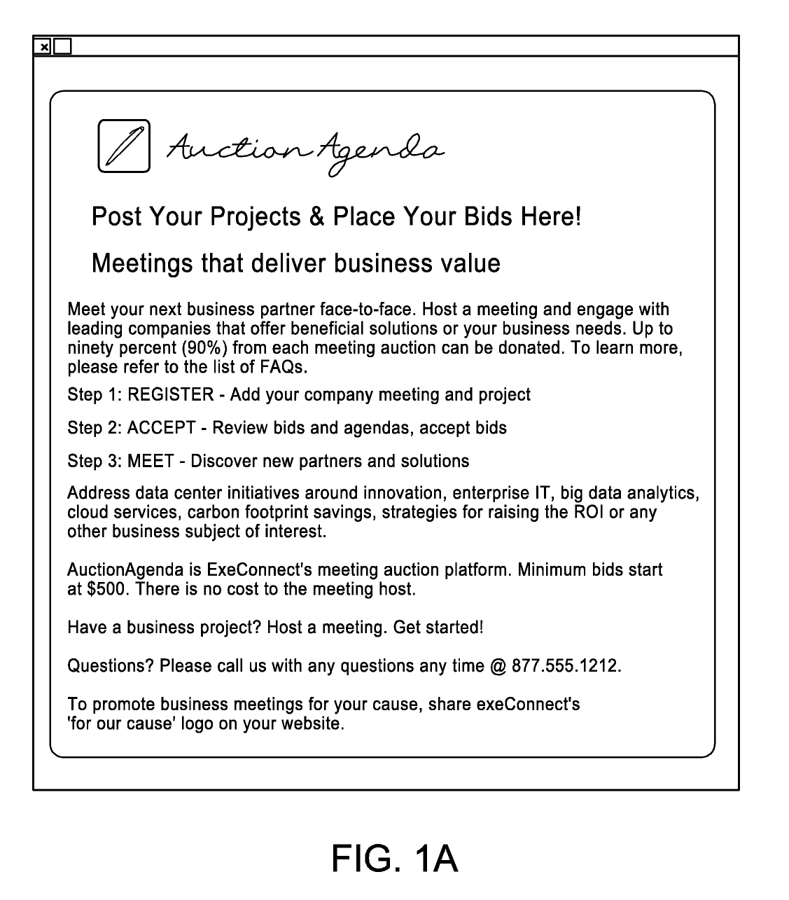

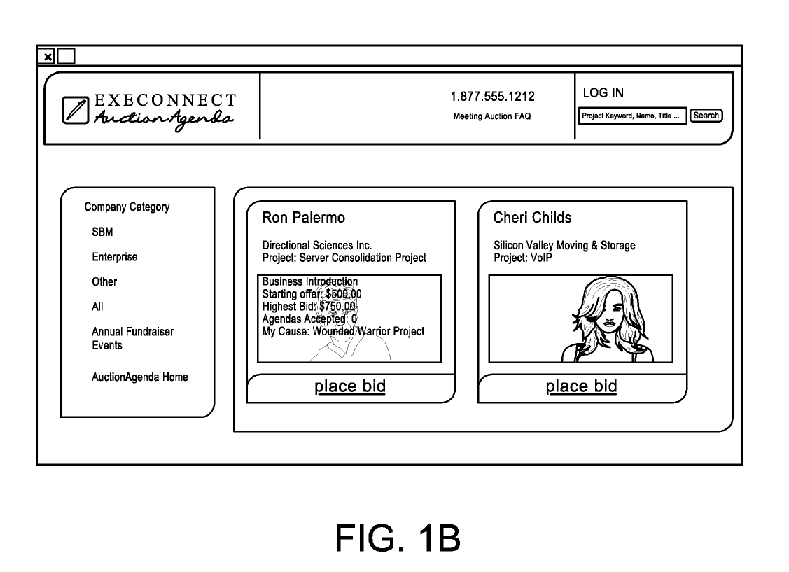

FIG. 1 shows a bid system that can be used to allowing bidding for a meeting.

A bid system 20 includes a bid oversight system 20 used to facilitate bidding on the meeting. Bid system 20 also includes a host system 11 used by a meeting host that hosts a meeting. Bid system 20 also includes a bidder system 12 used by someone bidding on the meeting. A network 10 is used to facilitate communication between host system and bid system 20 and between bidder system 12 and bid system 20. There can be many additional host systems and many additional bidder systems that communicate to bid system 20 through network 10.

For example, host system 11 can be a stand-alone system or implemented using some combination of hardware and software on a computing device such as a desktop computer, laptop computer, tablet computer or smart phone. Bidder system 12 can be a stand-alone system or implemented using some combination of hardware and software on a desktop computer, a laptop computer, a tablet computer or a smart phone. Network 10 can be implement using a local area network, a wide area network, a dedicated telecommunications network, the Internet, or some other networking hardware. Network 10 can be wireless or wired or some combination of wireless or wired. Bid system can be implemented using some combination of hardware and software on a computing device such as a server computer, a desktop computer, a laptop computer, a tablet computer or a smart phone.

A host register entity 21 within bid system 20 communicates with host system 11 through network 10. Host register entity 21 directs host system 11 through a registration process, for example using a registration form which a meeting host can complete using host system 11. For example the registration process includes a meeting host selecting a user name and password. Host register entity 21 signals host system 11 that the registration is ready to be confirmed. This confirmation can include a message that pops up on host system 11 that indicates an email with a link has been sent to host system 11 requesting the meeting host to respond. For example, selecting a link within the e-mail allows the meeting host to use host system 11 to login to bid system 20.

Once a meeting host is logged in, a host profile entity 22 provides a host on host system 11 with a “My Profile” link. Using the “my profile link” a meeting host on host system 11 can upload an identifying photo, and can edit information submitted during the registration process. If no photo is uploaded, then, for example a male or female silhouette image is shown, depending on a gender selected during registration.

A meeting auction entity 23 can be reached by a meeting host selecting a “my project meetings” link. When a meeting host selects an “add a meeting auction” link, meeting auction entity 23 provides through network 10 to host system 11, a meeting auction for host form. A meeting host, using host system 11 can complete the form and provide meeting requirements (mandatory field) in one of two ways. The meeting host, through host system 11 can enter information directly to meeting auction entity 23 or can upload to meeting auction entity 23 a file such as a Microsoft Word (MW) word document, an Adobe Acrobat (.pdf) document or a video. The meeting host indicates availability dates and what type of meeting it is, in person or online. The meeting host then chooses one of four options for their Budget, their minimum amount they want for their meeting ($500 or higher). The meeting host adds a cause, clicks on Terms of Service and Submits. For any mandatory field that is not completed, meeting auction entity will return an error message stating which field(s) need to be completed and that the submission will not successfully go through until correct information is provided. After the meeting auction is creating and uploaded online (main page), the meeting host can log out. A meeting host can add multiple project meetings for auction if the meeting host has multiple projects.

A host bid confirmation entity 24 contacts (e.g., sends an e-mail) to host system 11 through network 10 to indicate the meeting auction is live. An administrator for bid system 20 is also notified to allow the administrator to confirm details of the meeting.

A host review bid entity 25 handles the bid review process. Information about bids are forwarded to host system 11 through network 10, for example by e-mail. A meeting host can then login to bid system 20 and view any materials, such as documents or videos. Host review bid entity 25 allows a meeting host to accept or deny a bit. For every bid that is placed, an administrator of bid system 20 is allowed to by host review bid entity 25 to review and approve the file before the file is sent to host system 11.

A meeting host acceptance entity 26 allows a meeting host, that is logged in and that has reviewed documents, to accept or deny a meeting. Meeting host acceptance entity 26 generates and sends an email to a bidder stating that the bid has been accepted or denied. Meeting host acceptance entity 26 also allows a meeting host to request to change the date and/or time of the meeting. Meeting host acceptance entity 26, for example, generates an email and sends the e-mail to the bidder to accept or deny the change request. If the change request is denied, the meeting is not accepted. If the change request is accepted, the meeting is accepted. The meeting host is notified both by email and can see the change updated inside the portal created by bid system 20. If it's an in-person meeting, the location will be provided to bidder upon successful payment. If it's an online meeting, the meeting host is unable to accept a meeting until the meeting host provides a webinar link with login/audio dial-in info. Online meeting info is also provided to bidder upon successful payment.

A bid initiation entity 31 allows a bidder using bidder system 12 to initiate a bid. No registration is required. Bid initiation entity 31 provides bidder system 12 with immediate notification that a bid was placed.

A bid information entity 32 assures the bidder completes mandatory fields in bid form, including uploading a file document with proposed meeting agenda/introduction. Minimum information includes, for example, bidder contact information, bid price and a proposed parameter document or video for a meeting.

A bid notification entity 33 notifies a bidder on bidder system 12 when a meeting host has accepted or denied the bid. For example, the notification is through email.

A payment entity 34 receives payment, for example through an online payment system such as the PayPal payment system.

As discussed above, once the meeting is set/paid for, the bidder can use a bidder change entity to request a time/date change to the meeting. The meeting host can respond, selecting one of the following options: a) keep existing date/time, b) cancel meeting and bidder receives a full refund; c) reschedules with bidders acceptance; d) reschedules without bidders acceptance and bidder receives full refund.

Meetings that are auctioned on-line are conducted either in-person or on-line, they are auctioned to the public for bid. Parties that bid on meetings are required to submit a document or data, in most cases a proposed meeting agenda or proposal, when placing a bid. The meeting host (person who advertises on-line their meeting availability and criteria) will accept or decline bids on-line based on the information provided in the document or data submitted.

A meeting host registers on-line to add a meeting for auction. A person places a bid by completing the Place Bid form, which includes uploading a document or data for review, and submitting the bid by clicking the Place Bid button. Once a person submits their bid, they receive an email confirmation that their bid and document have been successfully submitted. The meeting host receives an email notification that a bid for their meeting has been placed which includes a link to the document or file submitted. The meeting host logs into their on-line account and reviews the information and meeting request, then accepts or declines the meeting bid. Once a meeting is accepted, the meeting host confirms the date and time proposed by email notification with the person who bid; the person who bid receives an email notification from the meeting host stating their meeting bid has been accepted (or declined). If accepted, the person who bid then pays for the meeting.

In a single meeting auction, a meeting host can receive and accept multiple bids and schedule multiple meetings. The highest bidder may not win the meeting, acceptance of bids is based upon the content in the document or data submitted being able to satisfy the meeting requirements or criteria. If there is more than one bid accepted in a single meeting auction, the meeting times are scheduled at different times and, in all cases, dates and times are agreed upon by both parties.

A method of bidding is used to qualify and win meeting time when bidding on a person's meeting in an on-line auction. This method includes submitting a document or data such as a meeting agenda or proposal when bidding. The person who has their meeting for auction (meeting host) accepts or declines bids based on the information stated in the document or data that was submitted on-line. A project, requirement, initiative or reason is required for hosting a meeting. The method also includes not accepting meeting bids based on the highest bid amount and accepting multiple bids and scheduling multiple meetings for a single meeting auction.

In an on-line meeting auction, an agenda or proposal provides a meeting host information as to how the bidder will potentially fulfill their needs and reasons for hosting a meeting. Once a meeting is submitted for auction by a meeting host, it is advertised on-line to the public and includes the meeting criteria or requirements. This method also protects the bidder from bidding on a meeting that may not be of value to them. Bids placed include a document or data, such as an agenda or proposal. The meeting host accepts or declines meeting bids based on the content submitted in the document at time of bidding.

A method of bidding is used to qualify meetings when bidding on a person's meeting in an on-line auction. Bidders are qualified for meetings in an on-line meeting auction. The method is particularly applicable to on-line meeting auctions where people bids on business meetings for business purposes.

A process for bidding on a meeting in an on-line meeting auction is described below.

One process for hosting a meeting is described with reference to FIG. 1A. FIG. 1A illustrates information about the meeting auction process for a meeting host, particularly Step 2 where the meeting host accepts bids and meetings after reviewing agendas submitted.

The beginning process for bidding on a meeting is described with reference to FIG. 1B. FIG. 1B illustrates a person's meeting posted for auction on-line.

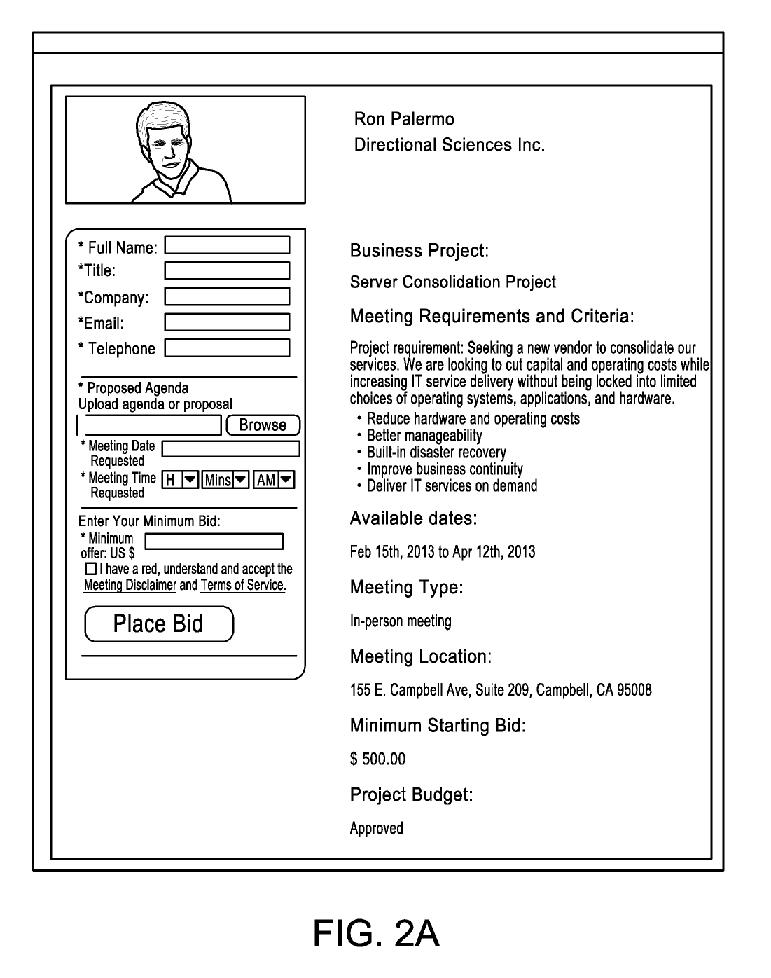

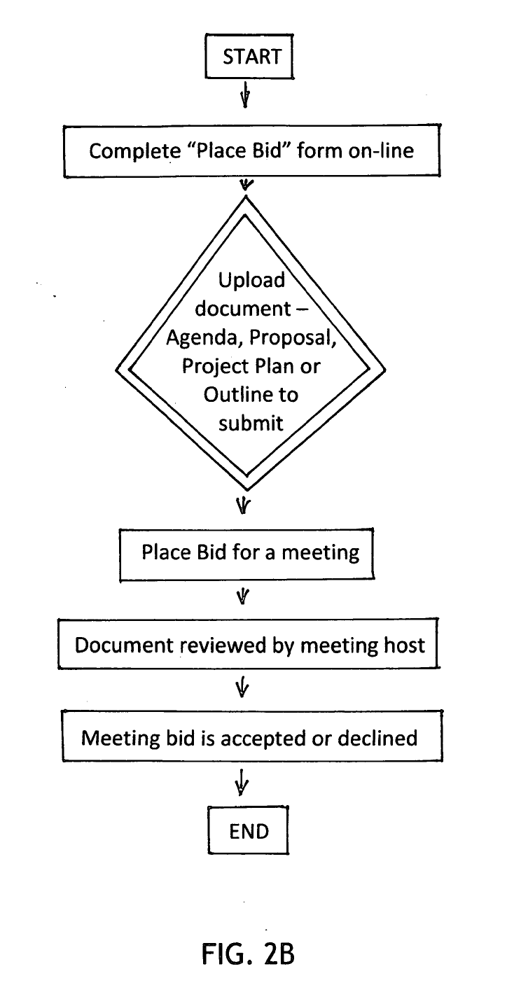

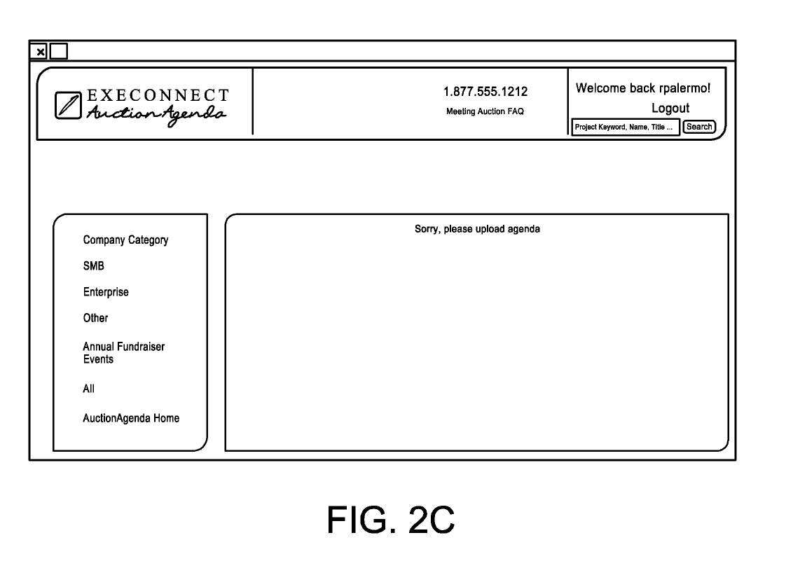

FIG. 2A illustrates how to place a bid in a meeting auction, showing an on-line submission form for bidding on a meeting; the form shows who the meeting is with, a title and company name, meeting requirements and criteria, and particularly where to upload required meeting agenda or proposal document; meeting requirements, criteria and availability are listed by the meeting host.

FIG. 2B is a drawing that illustrates the meeting auction bidding process: the bidder completes a Place Bid form on-line which includes uploading and submitting a document (meeting agenda or proposal); the bidder places bid; the document submitted is received and reviewed by the meeting host to determine if they want to accept the meeting bid; the meeting host accepts or declines the bid.

FIG. 2C illustrates a message that is received by the bidder stating that an agenda must be uploaded before move forward with placing a bid.

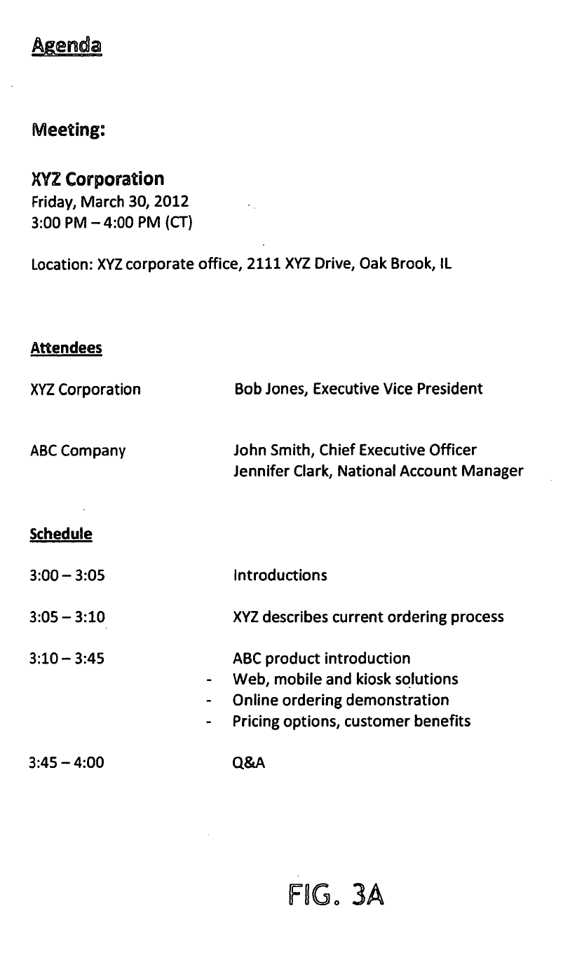

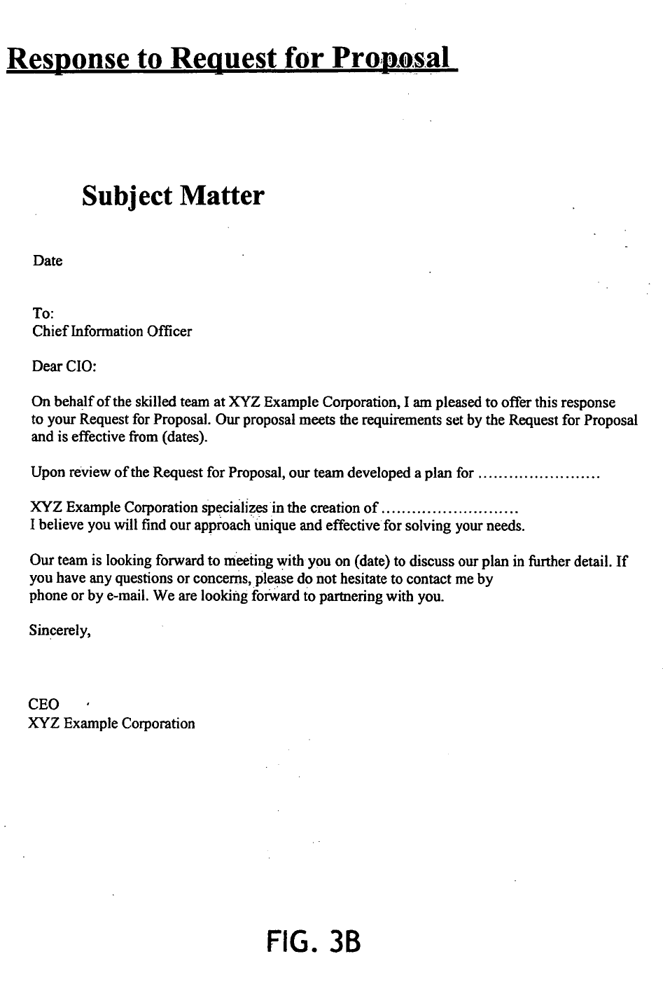

FIG. 3A illustrates an example of a meeting agenda. Shown in FIG. 3B is an example of a proposal.

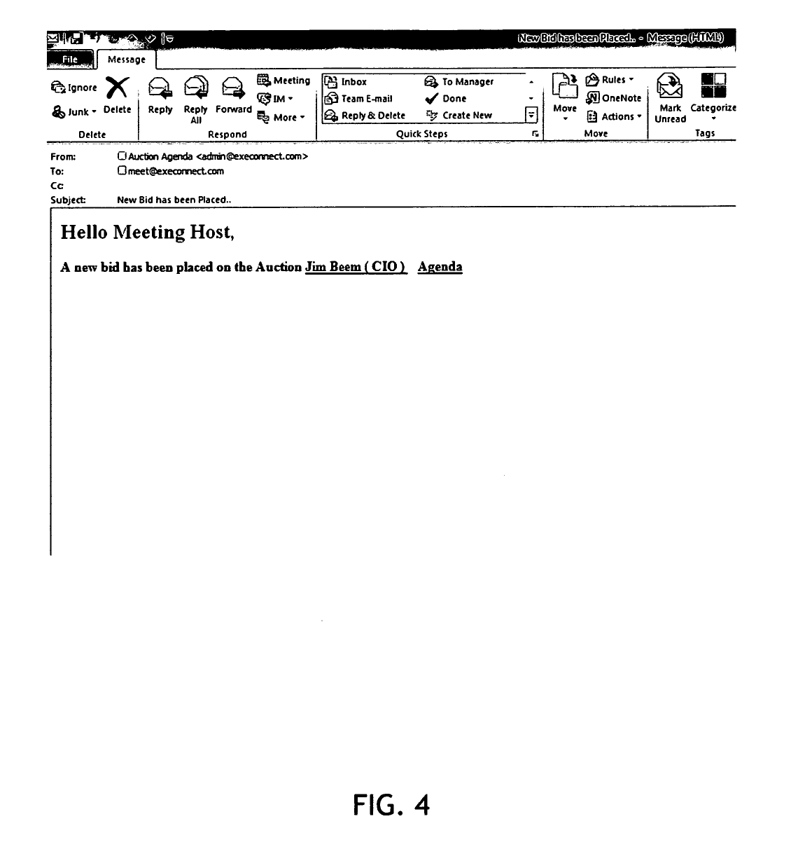

After a bidder has placed a meeting bid online, the meeting host receives notification of the bid with link to the agenda or document submitted. Shown in FIG. 4 is email communication informing the meeting host of a new bid for a meeting with them and a link to view the information about the bidder's agenda or proposal.

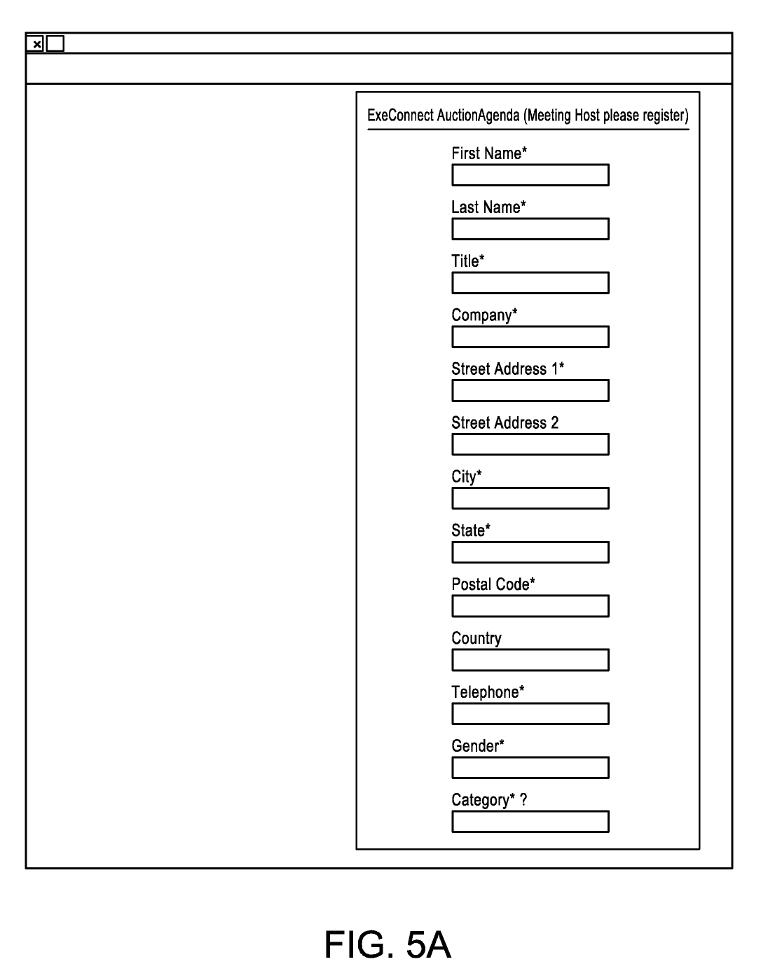

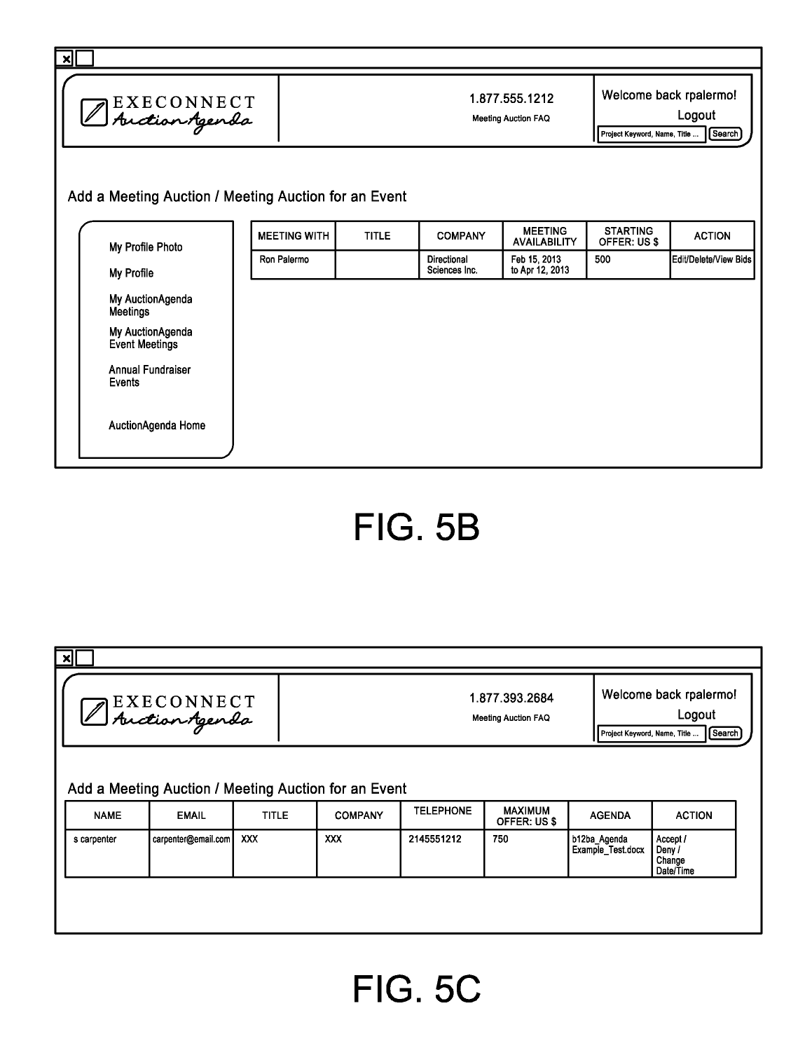

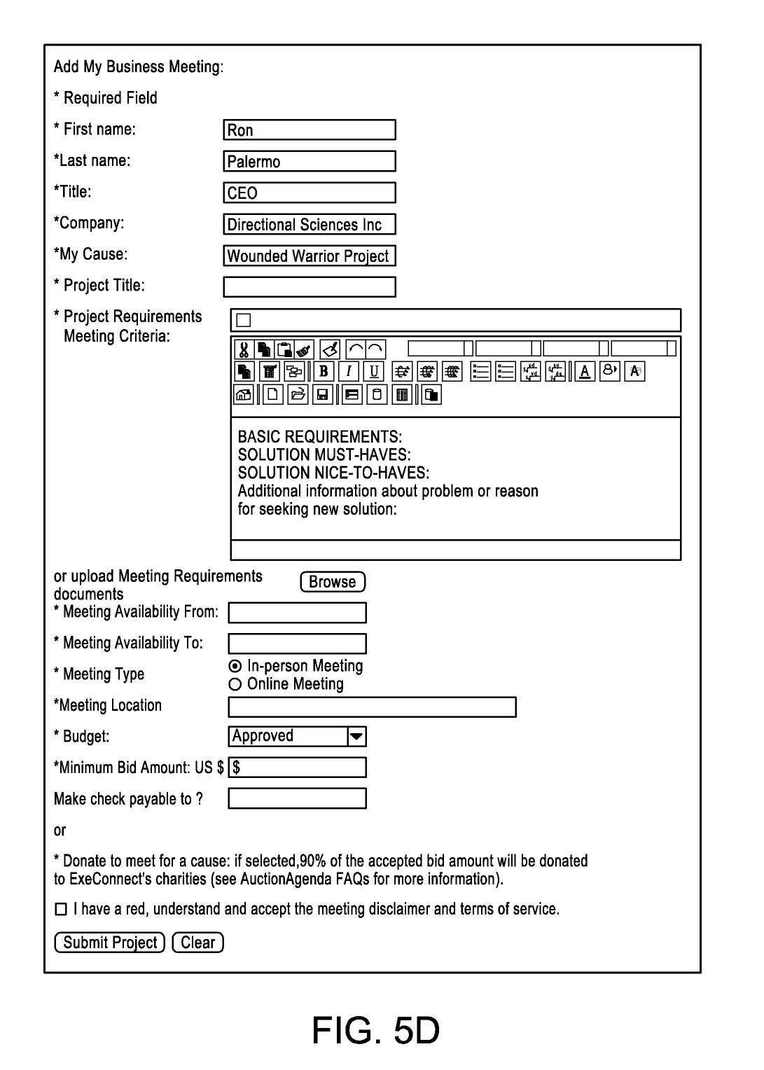

FIG. 5A illustrates an on-line form for meeting host to register a meeting auction. A meeting host completes and submits a form including but not limited to information about a project, requirement or initiative with meeting auction details including name, title, company, meeting availability, starting bid amount, photo, meeting type (in-person or on-line), meeting location, meeting title, meeting requirements and criteria, and budget. FIG. 5B illustrates an account dashboard and control panel for meeting host where meetings are added, edited, deleted and

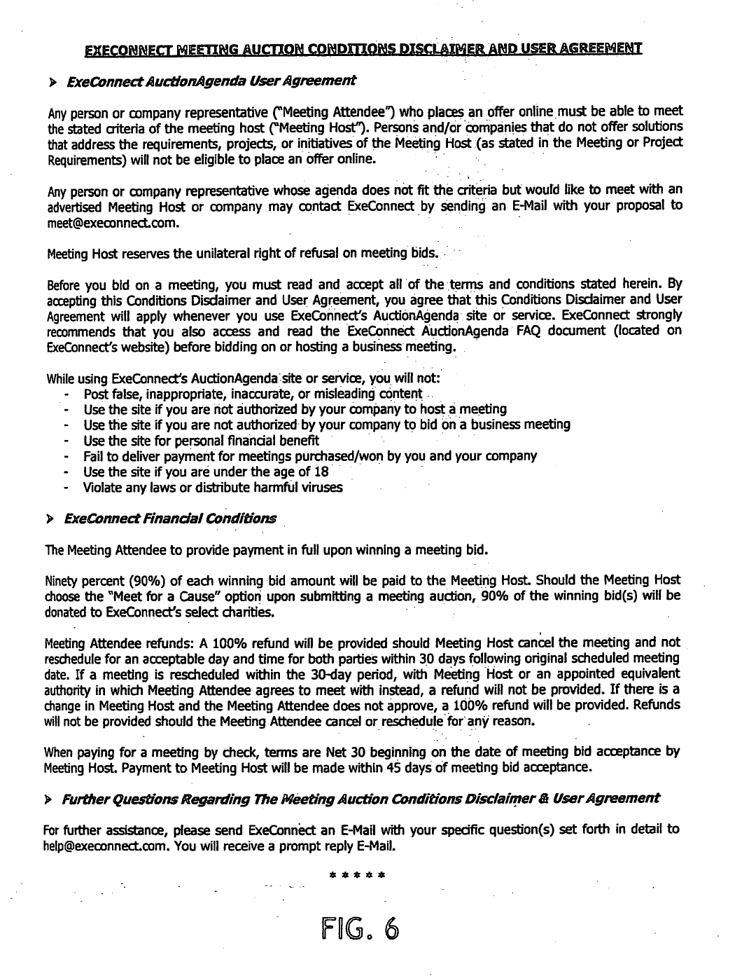

FIG. 6 illustrates meeting auction conditions and a disclaimer which is required to be read and accepted by bidders, it states that any person or company representative (meeting attendee) who places an offer online must be able to satisfy the stated criteria of the meeting host.

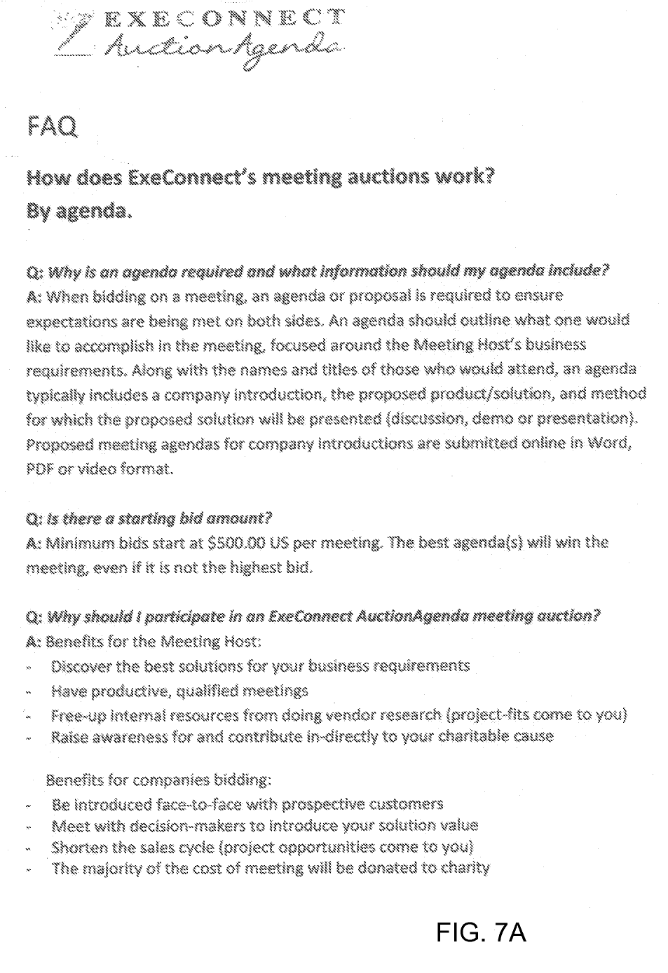

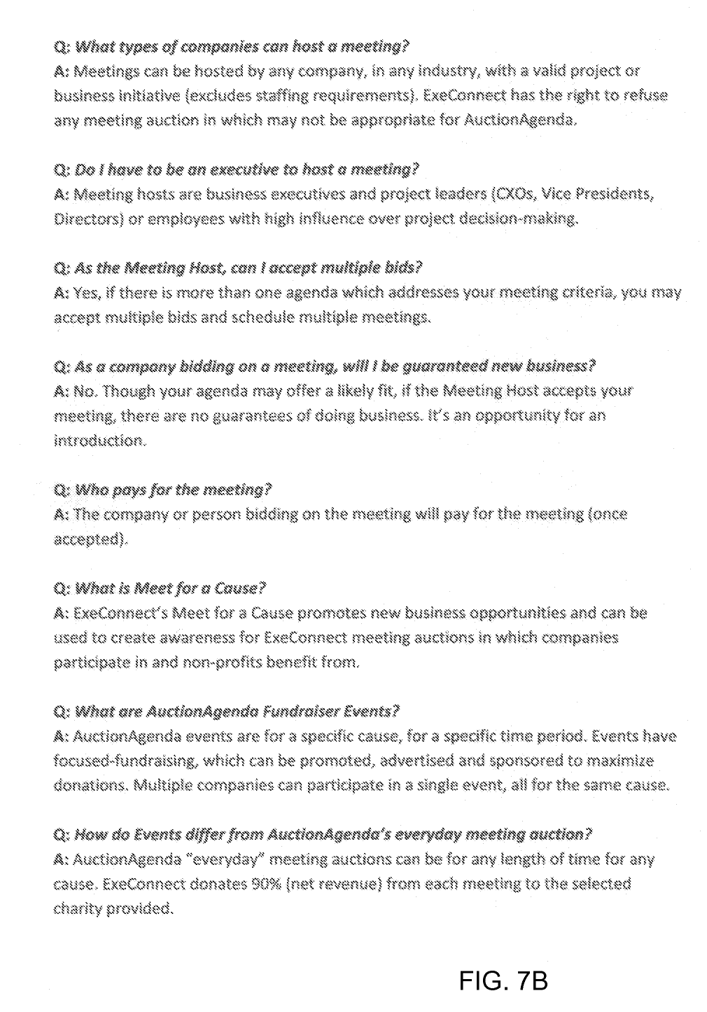

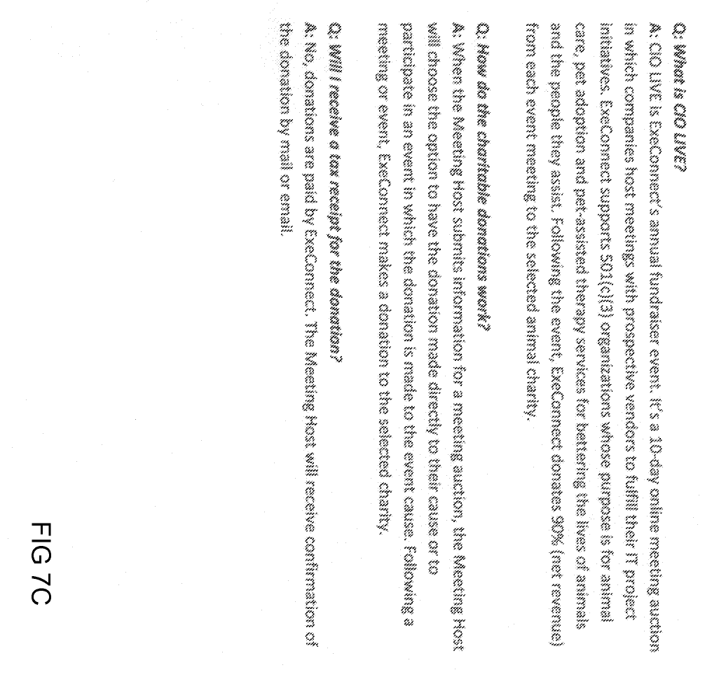

FIG. 7A, FIG. 7B and FIG. 7C show Frequently Asked Questions with answers about participating in a meeting auction, describing an agenda and meeting auction conditions for hosts and bidders, including the best agendas will win the meeting, even if it is not the highest bid, and multiple bids can be accepted as well as scheduling of multiple meetings.

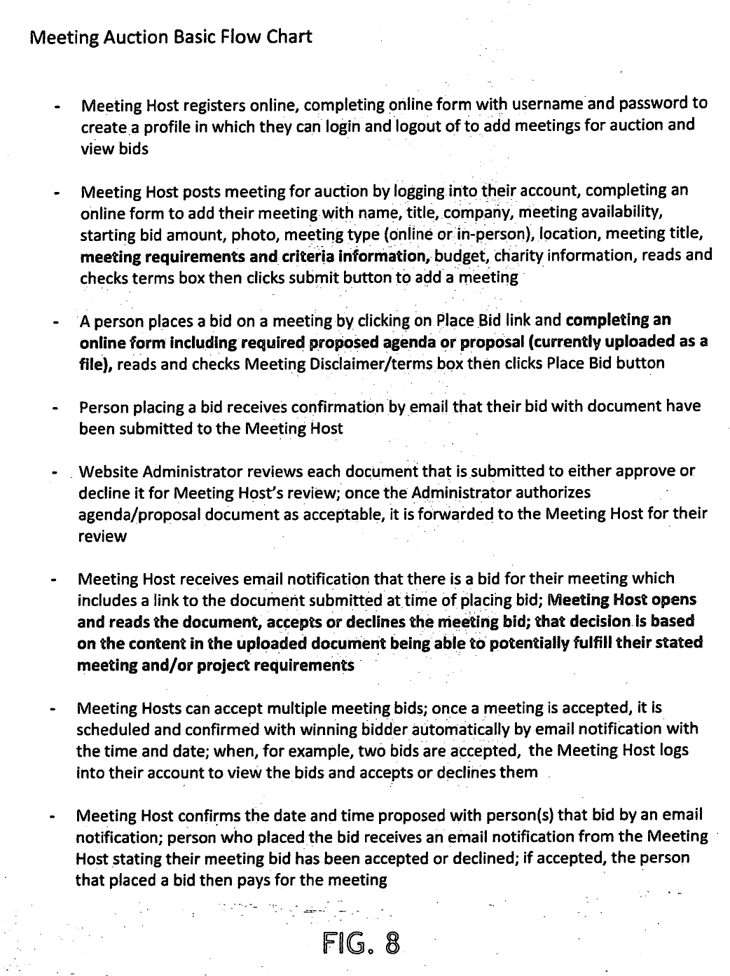

FIG. 8 shows a flow chart of a meeting auction process, which describes the meeting auction process.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A bid system comprising,
a network;
a bid host system connected to the network, that a meeting host used to specify information about a meeting;
a bidder system connected to the network on which a bidder can bid to attend the meeting; and,
a bid oversight system connected to the network, including:
a bid initiator entity, that allows the bidder to initiate a bid,
a bid information entity that assures the bidder provided minimum information about the bid from the bidder system to the bid oversight system, the minimum information including:
bidder contact information,
bid price, and
a proposed parameter document or video for a meeting, and
a host review bid entity that to the meeting host makes available the bid and the information about the bid collected from the bidder.

2. The bid system of claim 1 wherein the bid oversight additionally includes:
a bidder notification entity that notifies the bidder when the meeting host has accepted or denied the bid.

3. The bid system of claim 1 wherein the bid information entity additionally receives information about a requested time and a requested date for the meeting.

4. The bid system of claim 1 wherein the proposed parameter document or video for the meeting contains a proposed agenda for the meeting.

5. The bid system of claim 1 wherein the proposed parameter document or video for the meeting contains a proposal to be discussed in the meeting.

6. The bid system of claim 1 wherein the proposed parameter document or video for the meeting contains an outline to be discussed or followed in the meeting.

7. The bid system of claim 1 the proposed parameter document or video for the meeting contains a proposed project solution to be discussed in the meeting.

8. A bid oversight system comprising,
a meeting auction entity that receives from a meeting host on a host system meeting information about a meeting, the meeting information including:
availability dates,
type of meeting, and
minimum bid amount,
a bid initiator entity, that allows the bidder using a bidder system to initiate a bid,
a bid information entity that assures the bidder provided minimum information about the bid from the bidder system to the bid oversight system, the minimum information including::
bidder contact information,
bid price, and
a proposed parameter document or video for a meeting, and
a host review bid entity that to the meeting host makes available the bid and the information about the bid collected from the bidder.

9. The bid oversight system of claim 8, additionally comprising:
a bidder notification entity that notifies the bidder when the meeting host has accepted or denied the bid.

10. The bid oversight system of claim 8 wherein the bid information entity additionally receives information about a requested time and a requested date for the meeting.

11. The bid oversight system of claim 8 wherein the proposed parameter document or video for the meeting contains a proposed agenda for the meeting.

12. The bid oversight system of claim 8 wherein the proposed parameter document or video for the meeting contains a proposal to be discussed in the meeting.

13. The bid oversight system of claim 8 wherein the proposed parameter document or video for the meeting contains an outline to be discussed or followed in the meeting.

14. The bid oversight system of claim 8 the proposed parameter document or video for the meeting contains a proposed project solution to be discussed in the meeting.

15. A method for implementing a bid system comprising,
receiving, by a meeting auction entity within a bid oversight system from a meeting host on a host system, meeting information about a meeting, the meeting information including:
availability dates,
type of meeting, and
minimum bid amount,
allowing, by a bid initiator entity within the bid oversight system, a bidder using a bidder system to initiate a bid,
assuring, by a bid information entity, that the bidder provides minimum information about the bid from the bidder system to the bid oversight system, the minimum information including:
bidder contact information,
bid price, and
a proposed parameter document or video for a meeting, and
a host review bid entity that to the meeting host makes available the bid and the information about the bid collected from the bidder.

16. The method of claim 15 wherein the meeting information additionally includes a requested time and a requested date for the meeting.

17. The method of claim 15 wherein the proposed parameter document or video for the meeting contains a proposed agenda for the meeting.

18. The method of claim 15 wherein the proposed parameter document or video for the meeting contains a proposal to be discussed in the meeting.

19. The method of claim 15 wherein the proposed parameter document or video for the meeting contains an outline to be discussed or followed in the meeting.

20. The method of claim 15 the proposed parameter document or video for the meeting contains a proposed project solution to be discussed in the meeting.
